(19) United States
(12) Patent Application Publication
(10) Pub. No.: US 2003/0213520 A1
(43) Pub. Date: Nov. 20, 2003

(54) Apparatus for metered addition of gases

(75) Inventors: Thomas Prinz, Leverkusen (DE); Matthias Stenger, Monheim (DE); Peter Jahn, Leverkusen (DE); Ralf Duster, Duren (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(73) Assignee: Bayer Aktiengesellschaft, Leverkusen (DE)

(21) Appl. No.: 10/411,058

(22) Filed: Apr. 10, 2003

(30) Foreign Application Priority Data
Apr. 12, 2002 (DE) 10216143.7

(51) Int. Cl. F16K 31/12; F16K 31/36; B32B 5/02

(52) U.S. Cl. 137/487.5; 422/112

(57) ABSTRACT

Apparatus for maintaining a predefined pressure in one or more reactors to which pressures from 1 to 500 bar can be applied, with simultaneous measurement of the gas mass flow, comprising at least one buffer container (A) which is equipped with a pressure gauge (B) and can be filled with gas via at least one valve (C), and the buffer container (A) being connected to at least one reactor (F) which is likewise equipped with a pressure gauge (B′), characterized in that the connection between buffer container and reactor contains a restrictor (D) and a valve (E) which is controlled via a control unit (H) which is connected to the pressure gauges of the reactor (F) and of the buffer container (A) via control lines.

The invention relates to an apparatus for maintaining a predefined pressure in a reactor with simultaneous measurement of the gas mass flow, comprising at least one buffer container which is equipped with a pressure gauge and which can be filled with gaseous media via at least one valve, at least one restrictor which is connected to the buffer container and is connected via at least one valve to at least one reactor, the reactor likewise being equipped with a pressure gauge, and the valve or the valves being switched by a control element which is connected to the pressure gauges of buffer container and reactor.

In particular for chemical reactions which take place while consuming a gas or gas mixture, it is advantageous in the sense of process control to keep the pressure in the reaction chamber constant within a narrow range and to continue the metered addition of the amount of gas consumed.

It is also advantageous to register the amount of gas further metered in as accurately as possible in quantitative terms, in order to be able to follow the course of the reaction.

For sizes of the reaction chamber above about 50 ml and more, the use of gas mass flow meters and pressure-control valves in combination with a gas buffer is known. However, in particular for screening processes, process optimizations and for reasons of low investment costs, it is desirable to be able to regulate pressures and quantities of gas exactly even for relatively small reaction chambers.

The mass flow meters and controllers known hitherto, for example from Bronkhorst, for example type F-200-DFGB-22-K, MKS, for example type 1179, Tylan or Brooks, for example type 5850E or 5851E, have the disadvantage that they are designed only for narrow pressure ranges and a minimum gas mass flow which is not suitable for reaction chambers below 50 ml.

Pressure-controlled control valves or integrated pressure reducing valves, such as Tescom 54-2100, have the disadvantage that their construction takes up a great deal of physical space and, because of their large inherent volume, necessarily produce very large measurement errors and inaccuracies in the metered addition when used for small reaction chambers. This disadvantage is particularly serious in the metered addition of molecular hydrogen.

JP 07-324955 describes an apparatus with which the pressure on the secondary side can be kept constant independently of the pressure present on the primary side and with a high gas volume flow, the apparatus being insensitive to pressure fluctuations and disruptions on the primary side. Here, use is made of a combination of a diaphragm and control valve. The gas volume flow is measured continuously via an oscillating element. A typical range indicated for the gas volume flow is 190 l/h to 6000 l/h, which is many orders of magnitude above the range which is practical for the sizes of the reactor envisaged according to the invention.

The invention is therefore based on the following object. It is intended to find an apparatus which allows a predefined pressure to be maintained in a narrow range in a reactor having the volume of 0.1 to 50 ml, advantageously 1 to 30 ml, and permits the simultaneous measurement of the gas mass flow.

Such an apparatus should preferably permit the maintenance of a predefined pressure in a range from 1 to 500 bar, preferably 1 to 300 bar and particularly preferably 5 to 300 bar with a deviation of at most 1 bar, preferably at most 0.5 bar. Furthermore, the metered addition of 5 to 200 mmol of a gaseous medium over a time period of 0.5 to 12 hours should be made possible.

The object is achieved by an apparatus for maintaining a predefined pressure in one or more reactors, with simultaneous measurement of the gas mass flow, comprising at least one buffer container which is equipped with a pressure gauge and can be filled with gas via at least one valve, and the buffer container being connected to at least one reactor which is likewise equipped with a pressure gauge, characterized in that the connection between buffer container and reactor contains a restrictor and a valve which is controlled via a control unit which is connected to the pressure gauges of the reactor and of the buffer container via control lines.

In this case, the buffer container has, by way of example and preferably, a volume of 1 to 1000 ml, particularly preferably 1 to 100 ml, and quite particularly preferably 5 to 30 ml.

The restrictor constitutes a bottleneck in the connection between buffer container and reactor and, for example, can be designed in the form of a capillary and, for example, produced from steel, stainless steel, more highly alloyed steels or special materials, such as nickel-based alloys. The diameter can be, for example, 1 μm to 1000 μm, preferably 10 μm to 500 μm, particularly preferably 50 μm to 200 μm. The length of the capillary can be, for example, 1 mm to 10 000 mm, preferably 100 mm to 5000 mm and particularly preferably 500 mm to 2000 mm. However, other designs of the restrictor are also possible, for example flat rolled, round capillaries, welded flat plates with a defined surface roughness, porous sintered bodies with a defined porosity, micro-orifice plates or micro-nozzles. Such designs are sufficiently well known to those skilled in the art, for example from IDELCHIK, Handbook of Hydraulic Resistance, 3^{rd} edition 1994, CCR Press.

In a preferred embodiment, the restrictor has a rectangular slot-like flow cross section, the height of the slot being 5 to 500 μm, preferably 5 to 100 μm and particularly preferably 5 to 30 μm and the slot width being greater than the slot height.

Furthermore, preference is given to a restrictor which, in the inflow region, has at least two further openings, preferably at least five further openings and particularly preferably at least ten further openings, which are smaller than the average free flow cross section of the restrictor.

In the apparatus according to the invention, the valve is a controlled valve, which has short switching paths and times. The control is preferably carried out in a cyclic manner.

The control pulse has the effect of opening and automatically closing the valve after a defined opening time. The total opening time lies, for example, in the range from 1 ms to 600 s, preferably from 10 ms to 300 s and particularly preferably 100 ms to 2000 ms. The total opening time can, however, be permanently predefined as a device constant as desired or kept variable as a control parameter. In the latter case, particularly great flexibility is achieved and a gas volume flow can be controlled over a wide range.

In a preferred embodiment of the apparatus according to the invention, use is made of a valve with a pneumatic or hydraulic drive, which is provided with a flow duct that passes through the valve housing, a valve seat in the flow duct and a closure means that can be moved relative to the valve seat and comprises two components, the valve spindle with piston firmly connected on one side at a separate, freely moveable closure element, the piston being arranged in a hollow chamber, in particular a cylindrical chamber, and dividing the hollow chamber into an upper and lower hollow chamber and being guided such that it can move there, and also a fluid presser line connected to the upper hollow chamber part, and a lower fluid presser line, which is connected to the lower hollow chamber part, and which valve is characterized in that, the closure means is led through a centring plate above the flow duct, the said plate having a pressure release chamber and sealing means, in particular sealing rings, which separate the pressure release chamber from the flow duct and from the lower hollow chamber part.

Such a valve with integrated pneumatic drive has, for example, a modular plate-like structure with at least three plates, which include a lower base plate, an adjacent central housing plate and a fitted upper top plate. The plates are plugged together, in particular in the interior, with rotationally symmetrical centring internal fittings and a pneumatic piston with a valve spindle lengthened on one side, and all the internal fittings are sealed off from one another by elastic seals, so that four chambers which are separate and can be pressurized differently are produced, these are the upper and the lower hollow chamber (pneumatic chamber), an unpressurized dividing chamber (pressure relief chamber) and the process-side high-pressure chamber (flow duct). The valve spindle lengthened on one side permits the transmission of force between three pressurized chambers, so that the acting force is transferred from the upper or lower pneumatic chamber into the process chamber (flow duct) and, as a result, a closure element, for example a freely moveable closure element, is pressed into a valve seat or released and the passage of the valve is consequently opened or closed.

The preferred embodiments of the preferred valve for the apparatus according to the invention will be explained in more detail in the following text.

Of the four mutually separated chambers, at least two are continuously pressurized at a different pressure during operation.

The pressure relief chamber can be pressurized with a neutral gas or a neutral liquid, in order to apply a barrier pressure between process chamber and lower pneumatic chamber.

The barrier pressure applied can be monitored by a pressure sensor, so that in the event of a pressure deviation, an alarm is produced and a process is brought automatically into a safety position.

If it is installed vertically and a freely moveable closure element is used in the sealing seat, the valve simultaneously performs the task of a nonreturn valve, so that in the event of an inverse pressure difference arising suddenly, that is to say the pressure acting in the reactor is greater than the pressure present in the feed line of the base plate, reverse flow from the process is prevented. The function of the nonreturn valve can be cancelled when the valve is installed rotated through 180° during fitting, so that the top plate is positioned at the bottom.

In a preferred embodiment of the preferred valve, the area of the piston pressurized by the pressure fluids and the resultant force in relation to the cross section of the sealing area of the valve seat are dimensioned to be at least so large that the valve spindle counteracts the pressure in the inlet region of the flow duct when the upper hollow chamber is pressurized, and prevents flow through the flow duct.

In a preferred embodiment, following the fitting of the piston with spindle lengthened on one side, the remaining free height of the lower and upper hollow chambers of the top plate is of equal size and is chosen such that the entire opening travel is less than 10 mm, preferably less than 5 mm and particularly preferably less than 1 mm.

The sealing means in the valve in the region of the spindle are in particular formed independently of one another as elastic soft or round chord rings, lip seals, elastic shaped seals or in particular as a sliding seal.

The material particularly preferably used for the sealing means is elastomers such as silicone, Viton, Teflon or an EPDM rubber, it being possible for the cross-sectional shapes of the sealing rings to be round, square or else to have other specific cross-sectional shapes.

Use is therefore preferably made of a valve in which the valve housing is of multi-part design, and there exists at least one subdivision into a top plate to accommodate the hollow chamber, a housing plate to accommodate the pressure relief chamber and the flow duct, and also a base plate.

A variant in which the valve seat is fitted such that it can be detached from the valve housing is particularly preferred.

The cross-sectional area ratio of the pneumatic piston to the cross-sectional area of the valve spindle lengthened on one side in the region of the valve seat is less than 100, preferably less than 50 and particularly preferably less than 20.

The effective pressurized area of the piston with valve spindle fitted on one side and a small cross-sectional area has the effect of positive force magnification and transmission to the freely moveable, smaller closure element and its effective sealing area, so that the valve can be closed tightly with a low actuating force, even at high differential pressures.

The preferred valve has a setting screw, for example an adjusting spindle, particularly preferably a micrometer screw in the upper part of the valve housing, with which the upper end point of the piston and therefore the stroke of the valve spindle can be set and limited.

By using the setting screw, the maximum travel of the pneumatic piston with valve spindle can be reduced, so that with high differential pressures the piston travel, between the OPEN and CLOSED position of the valve is minimized and, as a result, abrasion of the spindle seal is reduced and the service life of the valve is increased substantially.

In a preferred embodiment of the valve preferably used, the opening and closing travel are dimensioned such that a natural deformation of the resilient seals on the valve spindle and on the piston is used to open and to close the valve with little wear.

The length of the piston travel behaves in particular inversely proportional to the differential pressure between the inlet and outlet opening of the preferred valve and is preferably at most 10 mm, particularly preferably at most 5 mm and in particular particularly preferably at most 1 mm.

In a particularly preferred embodiment, the valve preferred for the apparatus according to the invention has a freely moveable closure element which is seated in the extended axis of the pneumatic piston with the valve spindle extended on one side. For example, the closure element is seated in a depression in the housing plate with the valve seat, and the width of the concentric annular gap formed by the diameter of the depression and the diameter of the valve spindle is smaller than the diameter of the moveable closure element.

It is further preferred, in the preferred valve, for the sealing seat area of the valve seat to be designed to be flat or in particular conically tapered. The closure element is preferably formed as a sphere, cylinder, disc or cone.

The height of the depression in the valve seat to accommodate the freely moveable closure element, in a preferred design of the valve, is less than twice the height of the closure element, preferably less than the height of the closure element and particularly preferably less than half the height of the closure element.

The diameter of the depression or countersink in the closure plate is less than twice the diameter of the closure element, preferably less than 1.5 times the diameter of the closure element and particularly preferably less than 1.3 times the diameter of the closure element.

In the case of the conically concentric sealing area in the valve, the angle α, as viewed in relation to the horizontal, is preferably 0 to 70 degrees, particularly preferably 30 to 60 degrees and quite particularly preferably 40 to 50 degrees.

The closure element of the valve can consist of various materials, for example of steel, Hastelloy, glass, ceramic or of plastic.

In one preferred embodiment, the materials of the valve seat and of the closure element are different. The closure element preferably has a higher surface hardness than the valve seat.

The piston positioned in the cylinder chamber of the top plate can be equipped with additional compression springs, in order to assume a desired safety position, for example in the event of control air failure.

Preference is given to a valve in which a spring element is fitted in the upper hollow chamber part and acts on the valve spindle in the direction of the valve seat, or a spring element is fitted in the lower hollow chamber part and acts on the valve spindle in the direction opposite to the valve seat.

In a preferred variant, the closure element formed as a valve plate has an additional resilient seal in order to close the valve passage tightly.

An embodiment of the valve is preferably used in which the fluid pressure lines are operated with compressed air.

An embodiment of the valve is preferred in which a separable filter or screening fabric element is incorporated in the region of the feed line upstream of the sealing seat, in particular between base plate and sealing seat.

The incorporation of a filter holds back particles of dirt and other hard foreign particles, so that in particular a soft sealing seat or resilient seals are not damaged.

A tightly closing, modularly constructed, pneumatically controlled valve of this type is distinguished in particular by short opening and closing times, which permits the passage of extremely small amounts of gas even at high differential pressures and is also gastight after 100 000 switching cycles.

The combination of restrictor and valve with short switching time in the apparatus according to the invention permits the passage of quantities of gas in the range from 1 to 1000 mmol/cycle, preferably 1 to 200 mmol/cycle, particularly preferably 1 to 5 mmol/cycle at 1 to 500 bar and 20 to 300° C.

The valve used can be any desired valve that can be used for the aforementioned pressure ranges, such as pressure reducing valves (e.g. TESCOM 54-2100). It is also possible to use as a valve a valve as described above. If required, a time profile for the maximum pressure can also be predefined in a simple way.

Suitable materials for all the parts described which come into contact with compressed gases are metallic materials. In particular, these are stainless steels such as 1.4571, SS 316 or alloys, such as nickel-based alloys or, in the case of corrosive media, also special materials such as titanium, tantalum, possibly in the form of cladding.

The apparatus described proves to be particularly advantageous when the reactor serves as a reaction chamber for chemical reactions, in particular for those which proceed while consuming a gaseous medium. Such gaseous media, which are used in chemical reactions, can be, for example: hydrogen, carbon monoxide, carbon dioxide, chlorine, phosgene, ammonia or mixtures of such gases such as, in particular, hydrogen/carbon monoxide. If appropriate, these gas mixtures can also be further diluted with gases that are inert under reaction conditions. Typical examples are nitrogen and noble gases such as argon. The apparatuses according to the invention are therefore suitable in particular for carrying out hydrogenations, hydroformylations, carbonylations, carboxylations, aminations, oxidations and chlorinations. The apparatus according to the invention is also suitable in particular for carrying out chemical reactions in parallel, preferably those which proceed while consuming a gaseous medium.

The apparatus according to the invention is distinguished by the fact that the metered addition of a gaseous medium is possible in a small reactor over a very wide temperature and pressure range and whilst maintaining close pressure limits.

The invention will be explained in more detail below by way of example and using the figures, in which:

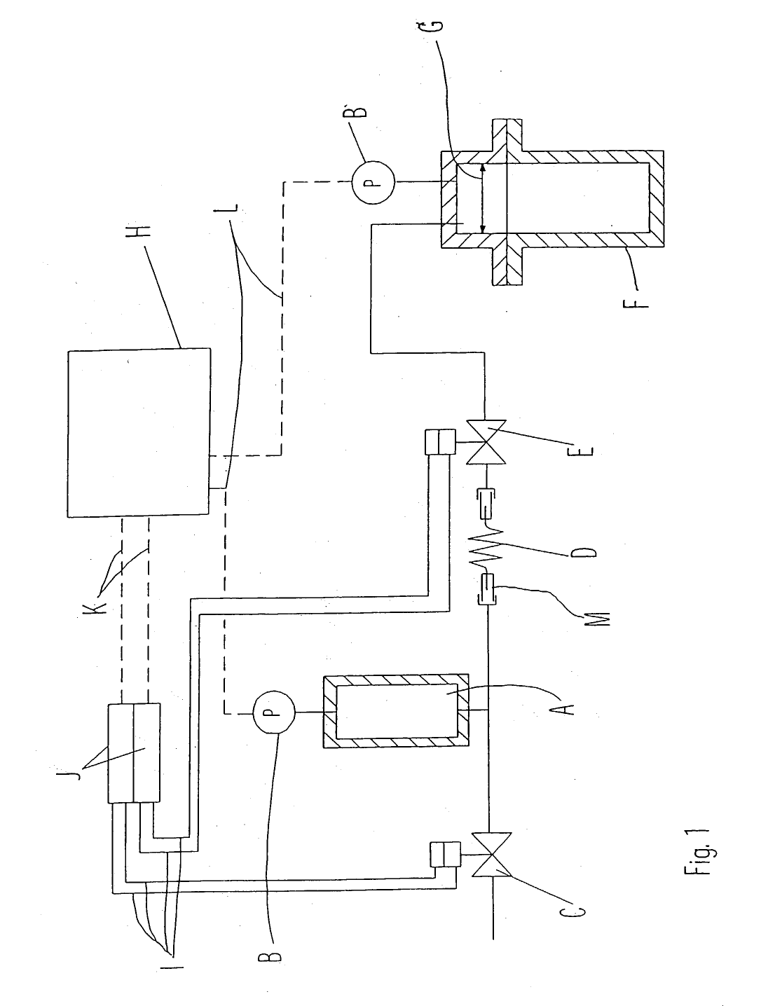

FIG. 1 shows a schematic representation of the apparatus according to the invention,

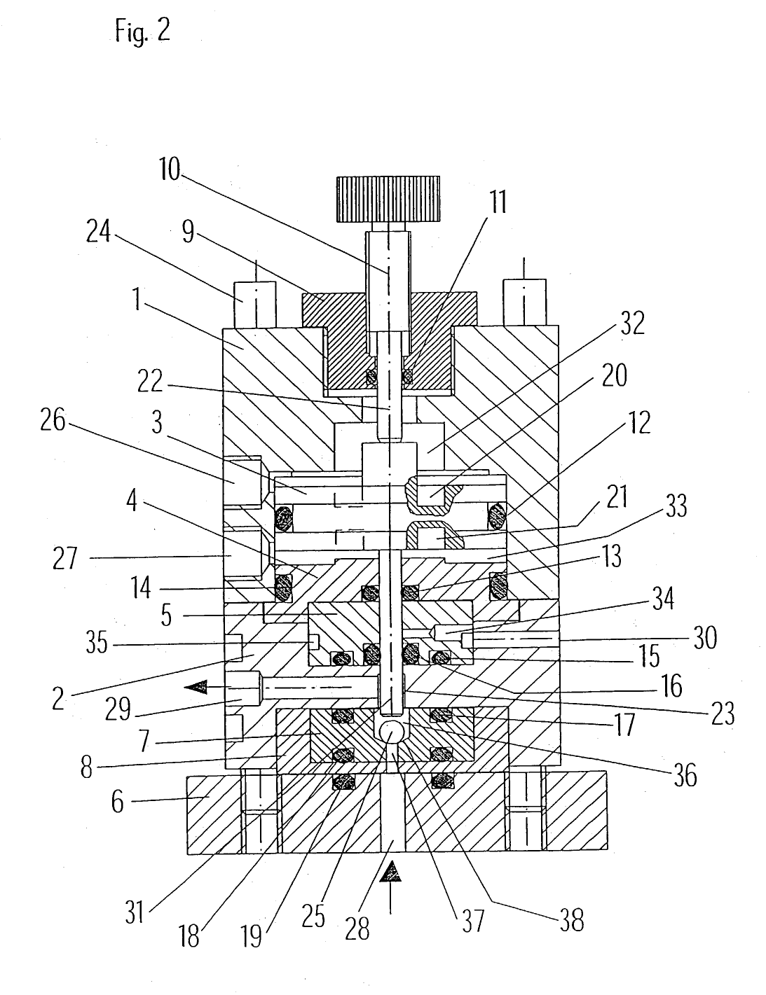

FIG. 2 shows a sectional illustration through the valve with all the individual parts,

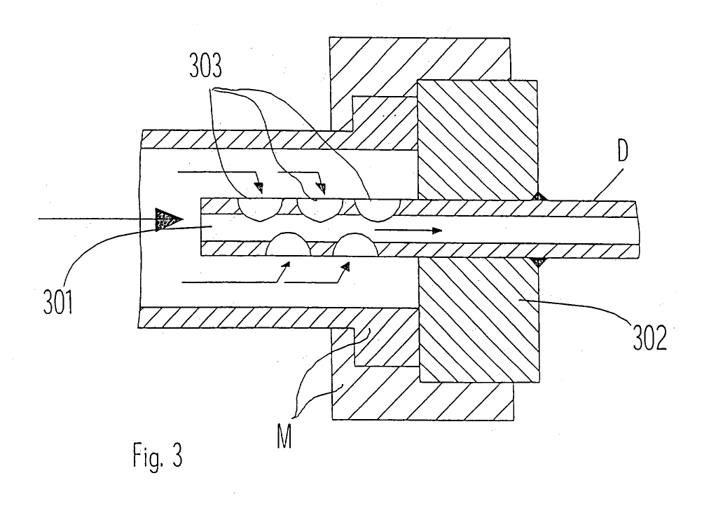

FIG. 3 shows a sectional illustration through the inflow region of the restrictor.

In the figures, the reference symbols are assigned as follows:

(List of Reference Symbols)

| A | Buffer container |
|---|---|
| B, B′ | Pressure gauge belonging to the buffer container 1 |
| C | Valve |
| D | Restrictor |
| E | Valve |
| F | Reactor |
| G | Pressure gauge belonging to the reactor F |
| H | Control unit |
| I | Pneumatic connecting line, for example hose |
| J | Electropneumatic 5/2-way valves |
| K | Connecting line for digital signals, for example cable |
| L | Connecting line for analogue signals, for example cable |
| M | Connecting element between capillary and restrictor, for example |
| | compression screw fitting |
| 1 | Top plate |
| 2 | Housing plate |
| 3 | Piston |
| 4 | Closure plate |
| 5 | Centring plate |
| 6 | Base plate |
| 7 | Valve seat |
| 8 | Housing of the valve seat |
| 9 | Threaded ring of the adjusting groove |
| 10 | Adjusting screw |
| 11 | Seal of the adjusting screw |
| 12 | Piston seal |
| 13 | Piston spindle seal |
| 14 | Outer closure plate seal |
| 15 | Centring plate seal to the housing |
| 16 | Valve spindle seal of the centring plate |
| 17 | Upper valve seat seal |
| 18 | Lower valve seat seal |
| 19 | Seal between base plate and valve seat housing |
| 20 | Concentric groove to accommodate a spring with a closing action |
| 21 | Concentric groove to accommodate a spring with opening action |
| 22 | Round pin on the adjusting spindle |
| 23 | Annular gap |
| 24 | Screws |
| 25 | Moveable closing element |
| 26 | Power connection |
| 27 | Power connection |
| 28 | Feed line in the base plate of buffer container A |
| 29 | Discharge bore in the housing to the reactor F |
| 30 | Radial housing bore |
| 31 | Valve spindle or piston spindle |
| 32 | Upper pneumatic chamber |
| 33 | Lower pneumatic chamber |
| 34 | Radial bore in the centring plate |
| 35 | Circumferential groove in the centring plate |
| 36 | Bore (countersink, depression) to accommodate the closure element |
| 37 | Feed bore |
| 38 | Conically concentric sealing surface in the valve seat |

### EXAMPLES

### Example 1

Characteristic Data:

| | |
|---|---|
| Buffer container: | Volume 25 ml, material 2.4602 |
| Reactor: | Volume 42 ml, material 2.4602 |
| Steel capillary: | Hamilton, No. 065999, SS tubing |
| | 304/G23S/1200 mm/pressure |
| | class 3. |

Digital input/output card for the Labmanager system from Hitec Zang.

FIG. 1 shows, by way of example, the construction of the apparatus according to the invention for the metered addition of gases. The gas supply is connected to the inlet to the pneumatically controllable valve (C). The pneumatically operated drive of the valve (FIG. 2) is connected by hose lines to, for example, an electro-pneumatic 5/2-way valve (J). The electro-pneumatic valve switches compressed air to the actuating drive for the open/close movement of the valve when the appropriate digital signal is transmitted from the control unit (H) via the electrical connections (K) (cables or lines). In the flow direction of the connected pressurized gas, downstream of the valve (C) there is the buffer container (A) having a pressure sensor (B), which is likewise connected to the control unit by an electric connecting line (L). The buffer container permits firstly the metered addition from a gas chamber at defined constant pressure, and secondly it is used to determine the quantity of gas (see below). Downstream of the buffer container, a restrictor (D), here a wound capillary, for example, is illustrated, and downstream of the restrictor a further controllable valve (E) is fitted and the gas outlet side of the valve is connected to the container (F), the container having a diameter (G) and a connected pressure sensor (B′). The valve (E) and the valve (C) are connected to the control unit in the same way as the pressure gauges and pressure sensors (B) and (B′). The restrictor (D) is provided on both sides by way of example with a screwed compression fitting (M) in order to permit quick changes during operation. The restrictor (D) used can be, for example, a stainless steel capillary from Hamilton, No. 065999, SS tubing 304/G23S/1200 mm/pressure class 3, or alternatively a metallic capillary which has been rolled completely flat, so that a rectangular passage gap is produced in the interior of the cold-formed capillary. The inner rectangular passage gap produced forms a rectangular restrictor which can be selected and prepared simply in terms of its length and as a result in terms of its pressure loss. Another possibility of fabricating a restrictor with a high resistance is to weld two flat iron plates with a defined surface roughness to each other. In this way, gaps parallel to the outer pressure-tight welds can be implemented, which likewise form a high pressure loss. In all the restrictor variants, the pressure loss rises linearly with the length of the restrictor.

The way in which the apparatus functions is such that when the actual value of the internal reactor pressure p_{F,Act} falls below a predefined limiting value, a signal is given to the valve (E) by the control unit (H), this valve opening for one cycle and closing again after the predefined opening time. This limiting value is normally formed as the difference between the desired value p_{F,Des}, which can also vary over time, and a suitably selectable permissible deviation Δₚ. During a delivery cycle (=opening time of the valve), a specific amount of gas then flows out of the buffer container (A) via a restrictor (D) into the reactor (F). This cycle is repeated until the predefined desired value has been reached. By selecting a capillary of suitable length and with a suitable selection of the pilot pressure in the buffer container A, the system may be tuned. A setting is preferably selected such that the pressure drop Δp in the reactor F can be compensated for with just a few valve cycles.

Care must be taken that the pressure in the buffer container (A) is higher than the desired pressure in the reactor (F). The setting of the pressure in the buffer container (A) should preferably be selected such that the pressure is between 10 and 50 bar higher than the desired pressure in the reactor (F). If the pressure in the buffer container (A) falls below a minimum pressure p_{A,min}, which must be higher than the predefined desired pressure in the reactor (F), is increased again by opening the valve (C). In the process, the buffer container (A) reaches its maximum pressure p_{A,max}.

With a known volume of the buffer container and the maximum and minimum values of the pressures p_{A,max} and p_{A,min} within a switching cycle of the buffer, the quantity of gas delivered per switching cycle at a given temperature can be determined in a simple way. The calculation of the gas mass flow is preferably carried out by using the thermal state equation of the ideal gas in accordance with:

$$Δ n = \frac{{V}_{A} \cdot ( {p}_{A , max} - {p}_{A , min} )}{ℛ \cdot {T}_{A}}$$

where:

Δn: quantity of gas delivered [mol]

p_{A,max}, p_{A,min}: maximum and minimum pressure in the buffer during a delivery cycle

V_{A}: Volume of the buffer [m^{3]}

[symbol] :

$$U niversal gas constant = 8.315 [ \frac{J}{mol \cdot K} ]$$

T_{A}: Absolute temperature in the buffer [K}

If required, another state equation can also be used which covers real gas effects. Furthermore, the Joule-Thompson effect can be taken into account. However, this generally has only a weak effect in the buffer, so that it is normally of subordinate importance.

In FIG. 2, a valve with an integrated pneumatic adjustment drive is shown in a sectional illustration. The valve has three main plates, the top plate 1, the housing plate 2 and the base plate 6. All the plates are held together, for example by four screws 24.

The top plate 1 has an attached bore in the interior. The bore forms the hollow chamber 32, 33, referred to as the pneumatic chamber below. The pneumatic chamber 32, 33 in the top plate 1 creates space to accommodate a piston 3 with a valve spindle 31 attached on one side. On its circumference, the piston 3 has a groove to accommodate the resilient piston seal 12. The piston seal 12 and the piston 3 divide the pneumatic chamber 32, 33 into a lower hollow chamber 33 and an upper hollow chamber 32 (also called the lower and upper pneumatic chamber).

The lower pneumatic chamber 33 is provided with a centring closure plate 4 and an associated outer seal 14, which seals the lower pneumatic chamber 33 with respect to the inner bore in the top plate 1. The piston spindle seal 13 seals the lower pneumatic chamber 33 with respect to the valve spindle 31, so that the lower pneumatic chamber is closed with respect to pressure.

The upper pneumatic chamber 32 and the lower pneumatic chamber 33 each have feed or discharge connections 26, 27 for fluids, for example pressurized air. In this way, depending on the open or closed position of the valve, the necessary adjusting force, as a result of compressed air at 6 bar, for example, can be led optionally through the line 27 to the respectively active lower surface or through the line 26 to the upper piston surface, so that the piston 3 with the valve spindle 31 is forced into the desired end position.

The closure plate 4 and the centring plate 5 on the inside centre the top plate 1 and the housing plate 2 in relation to each other, so that the valve spindle 31 fitted on one side to the pneumatic piston 3 in the centre of the valve body can be extended until it is in the flow duct 28, 29 close to the moveable closure element 25 (steel ball).

The lower plane of the centring plate 5 sits tightly in the housing plate 2, and the upper region of the centring plate 5 sits tightly in the closure plate 4, so that the valve spindle 31 with the seal 16 seals off the space in the valve housing (flow duct) that is touched by the product. The centring plate 5 has a further seal 15 to the housing plate 2, in order to prevent bypass leakage. Provided above the piston spindle seal 16 is a radial hole 34 which opens into a circumferential groove 35. The circumferential groove 35 adjoins a radial housing bore 30. As a result, the section of the valve spindle between the seal 13 and the seal 16 is freely ventilated (pressure relief chamber). As a result, in the event of failure of the valve spindle seals 13, 16, a pressure which arises can be relieved directly. For the user, there is also the possibility of checking the tightness of the valve.

The housing plate 2 is seated on the base plate 6 and has in its lower part a bore to accommodate the valve seat 7. If the valve seat 7 is produced from plastic, as shown in the example according to FIG. 1, it may be necessary to encapsulate the plastic valve seat 7 with an additional housing 8, in particular in the event of high process pressures. The valve seat 7 has an upper central bore 36 to accommodate the freely moveable closure element 25 and, in extension of the axis of the bore, an adjacent smaller bore 37, through which the substance flowing through from the feed line 28 is led. In the transition region of the bores 36, 37, a conical, concentric sealing surface 38 is formed, in order that the closure element can be centred centrally and sealed. The valve seat here is a disc which, on the upper level, has a seal 17 which prevents a bypass flow to the housing plate 2. A further seal 18 is placed between the valve seat 7 and enclosing housing 8.

The base plate 6 is sealed off by the seal 19 with respect to the housing 8 of the valve seat 7, so that a pressure present in the valve feed line 28 has to pass through the valve seat 7 in order to be able to leave the valve through the discharge bore 29 in the housing 2. The flow channel is formed here by the lines 28, 29 and the bores 36, 37.

On the vertical axis of the top plate 1, a threaded hole is additionally provided in order to accommodate a threaded ring 9. This ring 9 serves to hold the adjusting spindle 10 with attached round pin 22. The pin 22 extends as far as the upper pneumatic chamber and is sealed off from the outside by the seal 11. The adjusting spindle with attached pin forms the upper stop for the piston movement and, by means of the valve spindle 31 sitting on the piston 3, limits the maximum opening travel of the freely moveable closure element. The lower stop point of the freely moveable closure element is formed by the conically concentric sealing surface 38. The lower stop point is the CLOSED position and the upper stop point is the OPEN position of the valve.

The valve (E) functions as follows: when there is a process pressure present in the feed bore or duct 28 of the base plate 6, that is to say from the buffer container A, flow through the valve is prevented if, for example, compressed air is present in the upper pneumatic chamber 32 via the power connection 26 and an appropriate closing force is applied. The compressed air or the closing force resulting from it has the effect of forcing down the pneumatic piston 3 with attached valve spindle 31, so that the lower surface of the valve spindle 31 uses the force applied to the piston 3 to force the freely moveable closure element 25 into the concentric sealing seat 38. The force acting on the pneumatic piston is greater than the compressive force present underneath the closure element, which acts via the feed line 28 from the buffer container A. If the compressed air is then switched to the lower pneumatic chamber 33 and the upper pneumatic chamber 32 is relieved at the same time, the pneumatic piston 3 rises until it touches the lower surface of the pin 22 of the adjusting spindle 10. At the same time, the possibility for the freely moveable closure element 25 to move is enabled, so that if there is a pressure present underneath the closure element 25, the latter is forced upwards and opens the valve passage 28, 29. The product or medium present can then flow around the closure element 25, passes through the annular gap 23 which is formed by the round piston spindle and the larger vertical discharge duct, in order then to pass into the discharge bore 29 of the housing, which leads to the reactor F. The linking of the valve C and of the valve (E) with the further components of the invention is described in FIG. 1.

In FIG. 3, the gas inlet to the restrictor (D), for example a round capillary with an internal diameter of about 90 μm, is shown and the inlet side of the restrictor or of the capillary (301) is captively connected to a closure plug (302) belonging to a screw compression fitting (M). The inlet to the restrictor is formed in such a way that the welded-in or soldered-in end of the restrictor protrudes. There are a plurality of lateral gas inlet openings (303) along the protruding capillary, parallel to the mid-axis.

1. Apparatus for maintaining a predefined pressure in one or more reactors to which pressures from 1 to 500 bar can be applied, with simultaneous measurement of the gas mass flow, comprising at least one buffer container which is equipped with a pressure gauge and can be filled with gas via at least one valve, the buffer container being connected to at least one reactor which is likewise equipped with a pressure gauge, wherein the connection between the buffer container and the reactor comprises a restrictor and a valve which is controlled via a control unit which is connected to the pressure gauges of the reactor and of the buffer container via control lines.

2. Apparatus according to claim 1, wherein the restrictor used is selected from the group consisting of capillaries, flat rolled, round capillaries, welded flat plates with a defined surface roughness, porous sintered elements with a defined porosity, micro-orifice plates or micro nozzles or combinations thereof.

3. Apparatus according to claim 1, wherein the restrictor used is a capillary with a diameter of 1 μm to 1000 μm and a length of 1 mm to 10 000 mm.

4. Apparatus according to claim 1, wherein the restrictor has a rectangular slot-like flow cross section, the height of the slot is 5 to 500 μm and the slot width is greater than the slot height.

5. Apparatus according to claim 1, wherein, in an inflow region, the restrictor has at least two further openings which are smaller than the average free flow cross section of the restrictor.

6. Apparatus according to one claim 1, wherein the valve has a switching time of 1 ms to 600 s.

7. Apparatus according to claim 1, wherein use is made of a valve with a pneumatic or hydraulic drive, which is provided with a flow duct that passes through the valve housing, a valve seat in the flow duct and a closure means that can be moved relative to the valve seat, in particular a combination of valve spindle and closure element separate from the latter, a piston which is connected to the closure means and is guided such that it can move in a hollow chamber, in particular a cylindrical chamber, and also a fluid pressure line connected to the upper hollow chamber part and a lower fluid pressure line which is connected to the lower hollow chamber part, the closure means being led through a centring plate above the flow duct, the said plate having a pressure release chamber and sealing means, in particular sealing rings, which separate the pressure release chamber from the flow duct with the lower hollow chamber part.

8. Apparatus according to claim 7, wherein in the valve, the area of the piston pressurized by the pressure fluids, in relation to the cross section of the area of the valve seat, is dimensioned to be at least so large that when the upper hollow chamber is pressurized, the valve spindle counteracts the pressure in the inlet region of the flow duct.

9. Apparatus according to claim 7, wherein in the valve the length of movement of the piston is limited to at most 10 mm.

10. Apparatus according to claim 7, wherein in the valve the fluid pressure lines are operated with compressed air.

11. Process comprising reacting chemical compounds, wherein the process is carried out by using an apparatus according to claim 1.

12. Process according to claim 11, which comprises hydrogenation, hydroformylation, carbonylation, carboxylation, amination, oxidation or chlorination of a chemical compound.

13. Method of using an apparatus according to claim 1 comprising the metered addition of gases diluted with gases that are inert under reaction conditions or undiluted, selected from the group comprising hydrogen, carbon monoxide, carbon dioxide, chlorine, phosgene, ammonia or mixtures thereof.

14. Method comprising carrying out chemical reactions in parallel, wherein use is made of an apparatus according to claim 1.
